(19) United States
(12) Patent Application Publication
(10) Pub. No.: US 2023/0217846 A1
(43) Pub. Date: Jul. 13, 2023

(54) Soil-Working Device for Row Crops

(71) Applicant: Amazonen-Werke H. Dreyer SE & Co. KG, Hasbergen (DE)

(72) Inventors: Robert DIETRICH, Frohburg (DE); Tom MAHLER, Leipzig (DE); Reinhard SCHWOPE, Schkopau/ OT Wallendorf (DE); Rainer RESCH, Hagen a TW (DE)

(21) Appl. No.: 18/009,166

(22) PCT Filed: May 25, 2021
(86) PCT No.: PCT/EP2021/063793

§ 371 Date: Dec. 8, 2022

(30) Foreign Application Priority Data
Jun. 11, 2020 (DE) 20 2020 103 368.9

(51) Int. Cl. A01B 39/18; A01B 63/22; A01B 73/04; A01B 49/02

(52) U.S. Cl. CPC A01B 39/18; A01B 63/22; A01B 73/044; A01B 49/02

(57) ABSTRACT

A soil-working device (1) for row crops, comprising: a frame (2) which extends transversely with respect to the direction of travel (F) in a working position and which has a base segment (2A) and at least one boom (2B) which is able to be folded with respect to the base segment (2A); a folding device (3) for moving the at least one foldable boom (2B) between the working position and transport position in which it is folded by at least approximately 90 degrees; and a plurality of tool carriers (6a-6i) which are arranged on the frame via in each case a remotely adjustable height-guiding device (7a-7i), wherein soil-working tools (9a) assigned to individual plant rows (8) are arranged on the tool carriers (6a-6i). To provide a soil-working device which can be moved reliably between the working position and the transport position, there is provision that the folding device (3) and at least the height-guiding devices (7d-7f) of tool carriers (6d-6f) arranged on the base segment (2A) are coupled to one another by means of a, preferably hydraulic, coupling control device in such a way that, for each movement of a boom (2B) from the working position into the transport position, the height-guiding devices (7d-7f) of tool carriers (6d-6f) arranged on the base segment (2A) move the tool carriers (6d-6f) into a position in which they are lowered relative to the frame (2).

The invention relates to a soil-working device for row crops according to the preamble of claim 1.

Such a soil-working device is described in DE 10 2015 016 884 B4. The soil-working device is intended for cultivation, in particular removing weeds, for row crops and comprises a frame which extends transversely with respect to the direction of travel in the working position. For the cultivation of larger working widths, such frames regularly have a base segment and, at both free ends of the base segment, a boom which is able to be folded with respect to the base segment. The base segment thus forms the center piece of the frame and is therefore usually also used to arrange a coupling device to attach the soil-working device to a towing vehicle.

In order to fold the soil-working device into a less protruding transport position, in particular for transport on public roads, a folding device is provided in the case of a foldable frame design for moving the foldable booms between the working position and the transport position folded at least approximately, preferably at least, by 90 degrees, in particular upright. A plurality of tool carriers is arranged on the frame, i.e. the base segment and the booms, via a height-guiding device respectively. The height-guiding device can be configured as a parallelogram in this soil-working device and have a remotely adjustable actuator so that the assigned tool carrier can be lowered and raised remotely in respect to the frame.

Soil-working tools assigned to individual plant rows are arranged on the tool carriers. The soil-working tools are used to cultivate the row of crops to which they are assigned and can be configured, for example, as a finger wheel, hoe, chisel, weeder or similar. In the working position, the frame is usually carried by the towing vehicle at an adjustable height above the surface, from where the soil-working tools are lowered to the ground via the tool carriers cooperating with height-guiding devices. In order to assign the soil-working tools to a plant row, the tool carriers are usually arranged equidistant to each other on the frame. The distance of the tool carriers on the frame can correspond to the row distance of the plant rows on the area to be cultivated.

By adapting the arrangement of the tool carriers on the frame to the plant rows to be cultivated, problems can arise when moving the booms into the transport position, especially with particularly narrow row distances. To assume the transport position, it has been common practice up to now to move all tool carriers into their raised position by means of the height-guiding devices in order to generate additional ground clearance, so that the height-guiding devices at least partially rise up above the frame in the vertical direction. In the area where the booms are arranged on the base segment, however, this can lead to a collision, as tool carriers arranged on the boom are folded over tool carriers arranged on the base segment, especially when folded by at least 90 degrees.

The invention is therefore based on the object of providing a soil-working device which can be reliably moved between the working position and the transport position, in particular when the tool carriers are arranged at a small distance from each other. Preferably, it should be possible to arrange tool carriers directly in the transition area between the base segment and the boom without impairing a reliable movement between the working position and the transport position.

This object is achieved by the invention in that the folding device and at least the height-guiding devices of tool carriers arranged on the base segment are coupled to each another by means of a, preferably hydraulic, coupling control device in such a way that, for each movement of a boom from the working position into the transport position, the height-guiding devices of tool carriers arranged on the base segment move the tool carriers into a position in which they are lowered relative to the frame.

The invention makes use of the knowledge that a collision can be reliably avoided by automatically lowering tool carriers arranged on the base segment, since the critical installation space in the transition area between the base segment and the boom is released for tool carriers arranged on a boom that fold over to assume the transport position. The soil-working device can reach a working width of up to 6 metres and more due to the booms. Soil-working tools for cultivating a single plant row can be arranged on a tool carrier, wherein the tool carrier is preferably arranged vertically on the frame above the plant row to be cultivated. Preferably, a tool carrier can carry soil-working tools for cultivating two adjacent plant rows, wherein the tool carrier in working position is preferably arranged above, between the plant rows to be cultivated, on the frame. The folding device comprises one folding actuator per boom, which is preferably configured as a hydraulic cylinder. The height-guiding device may comprise at least one parallelogram link and has an adjustment actuator which is preferably hydraulically or pneumatically or electrically remotely adjustable. The coupling control device is preferably hydraulic.

The soil-working device is moved from the working position to the transport position by means of the coupling control device according to a predetermined movement sequence: The at least one boom starts to fold by means of the folding device, which causes the height-guiding devices of the tool carriers arranged on the base segment to lower the respective tool carriers, so that the installation space for the tool carriers folding over of the at least one boom is released. The height-guiding devices of the soil-working device can be controlled in groups or preferably individually. The soil-working tools can thus preferably be lifted out individually via the tool carriers, i.e., they can be brought into a raised position without contact with the ground.

In the working position of the soil-working device, the tool carriers are usually in an intermediate position from which they can follow the soil contour in the vertical direction. While tool carriers arranged on the at least one boom are preferably moved into a raised position and held there by means of their height-guiding devices in order to assume the transport position, the tool carriers arranged on the base segment are first lifted with it and then brought back into the working position, if this corresponds to the maximum lowered position, or lowered further so that they assume a lowered position in respect to the frame. In the lowered position, the height-guiding devices are located below a plane which is set up by the longitudinal direction of the frame, i.e., the base segment and/or the at least one boom, and the direction of travel and thus runs at least approximately horizontally in the working position of the soil-working device. The plane is divided into several partial planes by assuming the transport position, i.e., one partial plane per frame element: The partial planes are set up by the longitudinal direction of the base segment or boom and the direction of travel, so that the partial plane of a boom in transport position is at least approximately vertically aligned.

In a preferred embodiment of the soil-working device according to the present invention, the height-guiding devices of tool carriers arranged on a boom are coupled to the coupling control device in such a way that each time a boom is moved from the working position to the transport position, the height-guiding devices of tool carriers arranged on a boom move the tool carriers into a raised position. The tool carriers are usually in an intermediate position in the working position so that they can follow the soil contour. Compared to the working position, the tool carriers on the booms are thus raised. Compared to the working position, the height-guiding devices of the tool carrier arranged on the at least one boom are in the raised position essentially above a plane set up by the longitudinal direction of the boom and the direction of travel. “Above” here refers less to the direction of gravity and more to the fact that the height-guiding devices are moved from the intermediate, in particular lowered, position to the raised position from the starting position on one side of the plane through the plane to the other side of the plane. As a result of this embodiment, the soil-working device has a reduced transverse projection in the folded transport position.

Furthermore, a soil-working device according to the invention is preferred, that comprises at least one support wheel, which is arranged on the frame, in particular a boom, via a remotely adjustable swivel device, preferably on the side facing away from the tool carriers. Preferably, the soil-working device may comprise at least one support wheel per boom. It is also conceivable that at least one support wheel is arranged on the base segment. The at least one support wheel rolls on the ground in the working position of the soil-working device and thus guides the frame at an adjustable height. The at least one support wheel can be swiveled in height relative to the frame by means of the swivel device.

In a particularly preferred embodiment of the soil-working device according to the present invention, it is provided that the at least one swivel device is coupled to the coupling control device in such a way that whenever a boom is moved from the working position to the transport position, the swivel device swivels the at least one support wheel into a lift-out position. In the working position of the soil-working device, the at least one support wheel is lowered at an adjustable distance from the frame by means of the swivel device so that it rolls on the ground. To assume the transport position, the at least one support wheel is swiveled into a lifting position which removes the ground contact so that the support wheel is lifted out. In the lift-out position, the at least one support wheel is at least partially on a plane set up by the longitudinal direction of the frame and the direction of travel. It is advantageous here that the transverse projection of the soil-working device is reduced in the transport position.

In a further advantageous embodiment of the soil-working device according to the invention, the height-guiding devices are each configured to move the tool carrier into positions spaced at least 30 centimeters apart, preferably at least 40 centimeters apart. The spaced positions can be assigned to the lowered position and the raised position. The soil-working device is thus configured to raise the soil-working tools at least 30 centimeters, preferably at least 40 centimeters, above soil level, so that the crops to be cultivated can be given sufficient free access, for example during turning operations.

The height-guiding devices can each be configured to lower the circumference of a guide wheel attached to the tool carrier to a distance below a plane set up by the longitudinal direction of the frame, i.e. the base segment and/or the boom, and the direction of travel, which corresponds to at least twice the diameter of the guide wheel, and/or to raise the circumference of the guide wheel at least approximately into this plane.

The soil-working device according to the invention is further advantageously embodied in that the height-guiding devices comprise a releasable fixing device, which is preferably configured as a clamping device, for arranging the tool carriers on the frame, so that the tool carriers can be arranged on the frame at adjustable distances transversely to the direction of travel. Preferably, the frame, i.e., the base segment and the at least one boom, is configured as an H-section so that it has fixing surfaces for the positive locking arrangement of the fixing device. A tool carrier can also be easily dismantled by means of the releasable fixing device, so that the number of tool carriers arranged on the frame can be varied. The tool carriers can be adapted to the row width of the plant rows to be cultivated in a particularly useful way by means of the fixing devices. Preferably, the soil-working tools of two tool carriers arranged next to each other on the frame jointly cultivate a plant row for this purpose.

In a further preferred embodiment of the soil-working device according to the present invention, at least the height-guiding devices on a tool carrier arranged on a boom are lockable, preferably in the folded transport position of the soil-working device. A suitable locking device can be hydraulic or mechanical.

In another preferred embodiment of the soil-working device according to the present invention, it is provided that the coupling control device is configured as a hydraulic master circuit, so that whenever a boom is moved from the working position to the transport position, the height-guiding devices on the tool carrier arranged on the base segment can be controlled exclusively in the direction of the lowered position, the height-guiding devices on a tool carrier arranged on a boom can be controlled exclusively in the direction of the raised position and/or the swivel device can be controlled exclusively in the direction of the lift-out position. By means of the coupling control device configured as a master circuit, a safe and collision-free folding is thus guaranteed. The coupling control device can comprise at least one sensor element which is configured to monitor the assumption of the lowered position of tool carriers arranged on the base segment and/or the transport position of the booms. Preferably, the height-guiding devices of tool carriers arranged on the base segment are controllable by means of the coupling control device on the basis of the data of the sensor element, so that in transport position these height-guiding devices are prevented from being brought into a raised position.

In a further preferred embodiment of the soil-working device according to the invention, the frame comprises the base segment and two booms, wherein the booms are arranged in front of the base segment in the direction of travel so as to be foldable about a respective horizontal axis.

In a further embodiment of the above-described soil-working device according to the invention, the base segment and the booms are arranged adjacent to the horizontal axis, in particular transversely to the direction of travel, in a superimposed manner.

In order to move a soil-working device, which may be configured according to one of the above embodiments, with a frame which extends transversely to the direction of travel in the working position and has a base segment and two booms which can be folded relative to the base segment, from the working position into a transport position, into which the booms are folded upright through at least approximately 90 degrees by means of a respective folding actuator, wherein a plurality of tool carriers are arranged on the frame, the position of which relative to the frame is controlled by a respective height-guiding device, it is provided that the tool carriers arranged on the base segment are moved into a lowered position relative to the frame as soon as the folding actuators begin to fold the booms from the working position to the transport position.

In an advantageous further embodiment of the movement of the soil-working device from the working position to the transport position, it can be provided that support wheels and tool carriers arranged on the booms are raised relative to the frame as soon as the folding actuators start to fold in the booms.

Further details of the invention can be found in the example description and the drawings. In these drawings

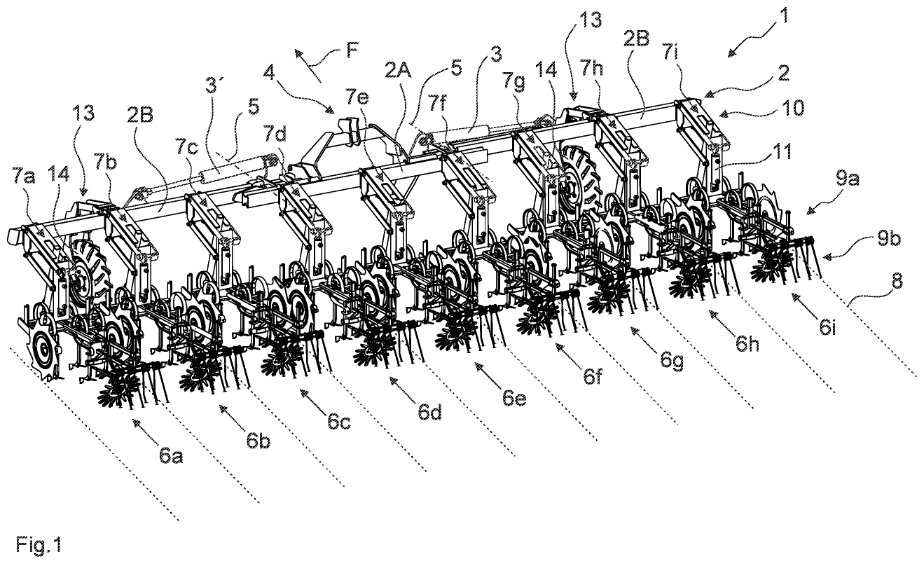

FIG. 1 shows a soil-working device in working position in perspective view,

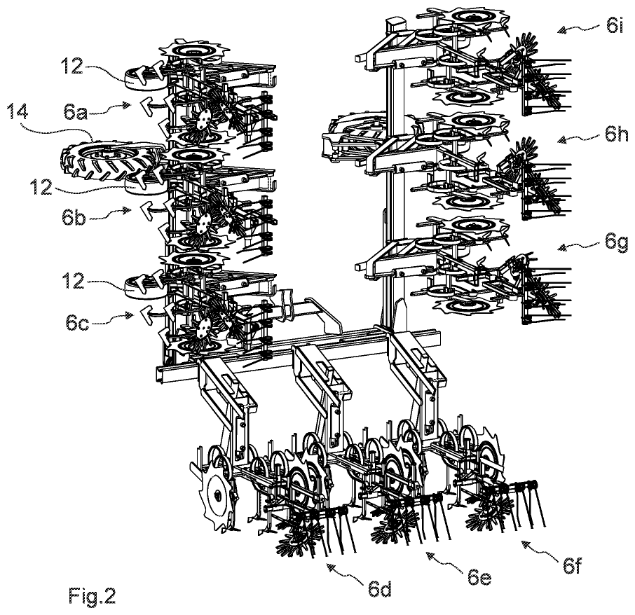

FIG. 2 shows the soil-working device in transport position in perspective view,

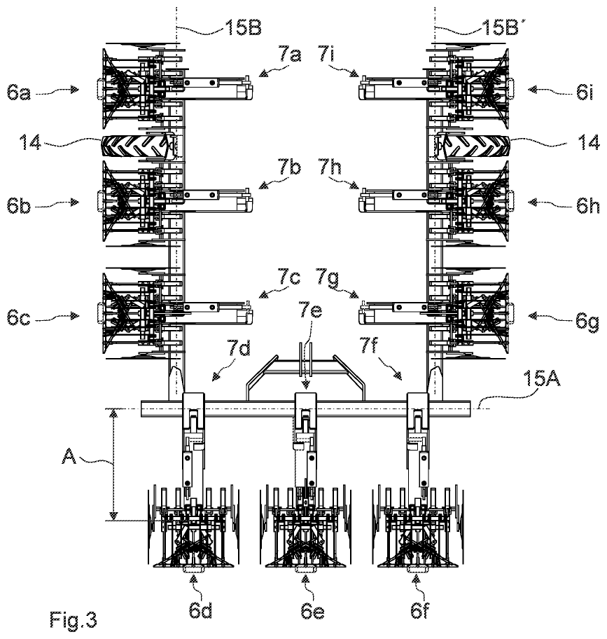

FIG. 3 shows the soil-working device from FIG. 2 in rear view, and

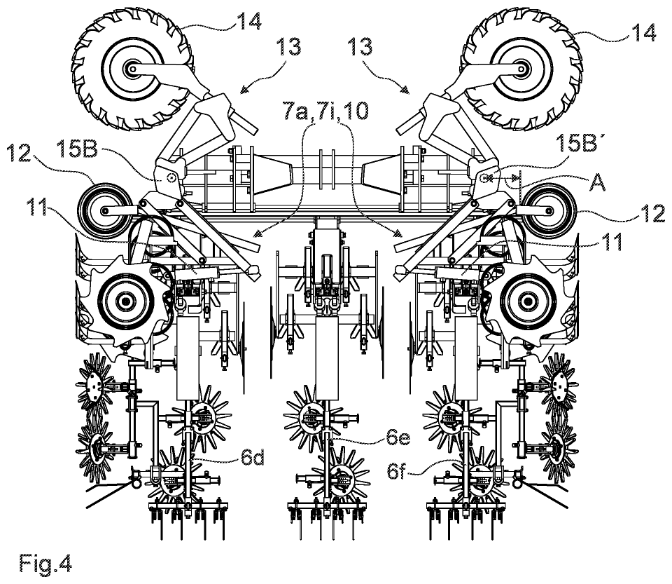

FIG. 4 shows the soil-working device from FIG. 2 in a plan view.

A soil-working device 1 configured as a hoeing machine for row crops is shown in FIG. 1 in a working position. The soil-working device 1 comprises a frame 2 which has a central base segment 2A and two booms 2B which is able to be folded with respect to the base segment 2A and which extends transversely to the direction of travel F in the working position shown. The base segment 2A is used, among others, to arrange an attachment device 4 by means of which the soil-working device 1 can be coupled to a towing vehicle that is not shown. The two booms 2B connect to the free ends of the base segment 2A transversely to the direction of travel F and are arranged in front of the base segment 2A in the direction of travel F. By means of a folding device 3, which has two folding actuators configured as hydraulic cylinders 3′, the booms 2B can be moved from the at least approximately horizontal working position into an upright transport position folded at least approximately 90 degrees, as shown in FIG. 2. For this purpose, the hydraulic cylinders 3′ are actuated from the working position, as shown in FIG. 1, so that their piston rods are retracted, whereby the booms 2B are each folded about a horizontal axis 5 into the transport position. The base segment 2A and the booms 2B are arranged superimposed in the area of the horizontal axis 5 transversely to the direction of travel F.

The soil-working device 1 further comprises a plurality of tool carriers 6a-6i arranged on the frame 2 transversely to the direction of travel F. The tool carriers 6a-6i are each arranged on the base segment 2A or one of the booms 2B via a remotely adjustable height-guiding device 7a-7i and carry soil-working tools 9a assigned to individual plant rows 8 as well as soil-working tools configured as weeders 9b. In this soil-working device 1, the height-guiding devices 7a-7i comprise a parallelogram-type suspension 10, which can be deformed in an adjustable manner by means of an actuator 11, which in this case is configured as a hydraulic cylinder, and can thus be adjusted remotely. By selectively deforming a parallelogram-type suspension 10 by means of the actuator 11, the assigned tool carrier 6a-6i can be supported at an adjustable height relative to the frame 2.

For the arrangement of the tool carriers 6a-6i on the frame 2, the height-guiding devices 7a-7i have at their front free end a releasable fixing device configured as a clamping device. The tool carriers 6a-6i can thus be fixed to the base segment 2A and the booms 2B at distances adapted to the row distances of the plant rows 8. The frame 2 can be designed as an H-section, wherein the clamping device has two fixing claws that embrace the H-section and can be braced against each other.

The soil-working devices 9a, which are assigned to individual crop rows 8, are configured in this soil-working device 1 in the direction of travel F as hoe guard rollers, hoe knives and finger wheels and are supplemented by the trailing weeders 9b. The tool carriers 6a-6i are each arranged on the frame 2 transversely to the direction of travel F between two plant rows 8 to be cultivated, so that hoe guard rollers and finger wheels arranged on adjacent tool carriers 6a-6i jointly cultivate a plant row 8 and the hoe knives and the weeder 9b are guided between two adjacent plant rows 8. The tool carriers 6a-6i also carry a leading guide wheel 12, wherein by the distance of the wheel to the tool carrier 6a-6i the working depth of the soil-working tools 9a, 9b can be adjusted. The distance between the guide wheel 12 and the tool carrier 6a-6i can be adjusted manually, for example by means of a crank, or remotely, for example hydraulically.

The soil-working device 1 further comprises two support wheels 14 arranged on the side of the frame 2 facing away from the tool carriers 6a-6i, each via a remotely adjustable swivel device 13. In this soil-working device 1, the support wheels 14 are arranged on the booms 2B and roll on the soil to be cultivated when the soil-working device 1 is in the working position, so that the frame 2 is supported on them. By means of the swivel devices 13, the support wheels 14 can be swivelled up into a lift-out position, which ends the ground contact and is shown in FIGS. 2-4.

In the working position of the soil-working device 1 shown in FIG. 1, all tool carriers 6a-6i are in an intermediate position, in which the respective guide wheel 12 rolls on the ground and the actuators 11 are uncoupled from the height-guiding devices 7a-7i, so that the tool carriers 6a-6i or the soil-working tools 9a, 9b fixed to them can follow the ground contour by means of the guide wheel 12 cooperating with the parallelogram-type suspension 10. The folding device 3 is provided to move the soil-working device 1 into the transport position shown in FIGS. 2, 3 and 4. It should be noted here that tool carriers 6a-6c, 6g-6i arranged on the booms 2B fold over the tool carriers 6d-6f arranged on the base segment 2A. In order to avoid collisions between the height-guiding devices 7a-7i on the booms 2B and tool carriers 6a-6i arranged on the base segment 2A, a coupling control device is provided: The folding device 3 and the height-guiding devices 7d-7f of tool carriers 6d-6f arranged on the base segment 2A are coupled to each other by means of the coupling control device in such a way that, for each movement of the booms 2B from the working position into the transport position, the height-guiding devices 7d-7f of tool carriers 6d-6f arranged on the base segment 2A move the tool carriers 6d-6f into a position in which they are lowered relative to the frame 2. In the lowered position, the actuators 11 of the height-guiding devices 7d-7f are preferably completely retracted so that the parallelogram-type suspensions 10 extend downwards from the base segment 2A and thus release the installation space for the folding over parts of the soil-working device, in particular in the area above the horizontal axis 5, as shown in FIG. 3.

In the lowered position, the height-guiding devices 7a-7i are located essentially below a plane 15A, 15B, 15B′ which is set up by the longitudinal direction of the frame 2, i.e. the base segment 2A and/or the booms 2B, and the direction of travel F and thus runs at least approximately horizontally in the working position of the soil-working device 1. The plane 15A, 15B, 15B′ is divided into several partial planes 15A, 15B, 15B′ by assuming the transport position, i.e. one partial plane 15A, 15B, 15B′ per frame element 2A, 2B: The partial planes 15A, 15B, 15B′ are set up by the longitudinal direction of the base segment 2A or boom 2B and the direction of travel F, so that the partial plane 15B, 15B′ of a boom 2B in transport position is at least approximately vertically aligned.

The height-guiding devices 7a-7c, 7g-7i of tool carriers 6a-6c, 6g-6i arranged on a boom 2B are also coupled to the coupling control device in such a way that each time a boom 2B is moved from the working position to the transport position, the height-guiding devices 7a-7c, 7g-7i of tool carriers 6a-6c, 6g-6i arranged on a boom 2B move the tool carriers 6a-6c, 6g-6i into a raised position. In the raised position, the actuators 11 of the height-guiding devices 7a-7c, 7g-7i are preferably completely extended so that the parallelogram-type suspensions 10 extend upwards from the booms 2B and thus occupy the installation space released, in particular in the area of the horizontal axis 5, in the transport position. The height-guiding devices 7a-7c, 7g-7i are in the raised position disposed essentially above the plane 15A, 15B, 15B′ set up by the booms 2B and the direction of travel F, as shown in FIGS. 3 and 4. In transport position, the height-guiding devices 7a-7c, 7g-7i are thus disposed between the partial planes 15B, 15B′, as shown in FIG. 3. “Above” thus refers less to the direction of gravity and more to the fact that the height-guiding devices 7a-7c, 7g-7i are moved from the lowered position to the raised position, i.e. from the starting position on one side of the plane 15B, 15B′ through the plane 15B, 15B′ to the other side of the plane 15B, 15B′. The soil-working device 1 thus has a reduced transverse projection in the folded transport position, wherein the height-guiding devices 7a-7c, 7g-7i of tool carriers 6a-6c, 6g-6i arranged on the booms 2B can be locked in the transport position. Unintentional swiveling of these tool carriers 6a-6c, 6g-6i could, for example, endanger other road users and is thus effectively avoided.

The tool carriers 6a-6i are in the working position of the soil-working device 1 at least approximately in the lowered position. In order to protect the crops when driving into a wedge situation or during turning operations on the area to be cultivated, the soil-working tools 9a, 9b can be lifted out via the height-guiding devices 7a-7i cooperating with the corresponding tool carriers 6a-6i for each tool carrier 6a-6i. For this purpose, the corresponding tool carrier 6a-6i is brought into its raised position. In order to continue to give the crops sufficient clearance as they grow, the lowered and raised positions can be at least 40 centimeters apart. The height-guiding devices 7a-7i are thus each set up to move the tool carrier 6a-6i to positions spaced at least 40 centimeters apart. By looking at FIGS. 3 and 4 together, it can be seen that the height-guiding devices 7a-7i are each configured to lower the circumference of the guide wheel 12 to a distance A below the plane 15A, 15B, 15B′ which is between the single and double diameter of the guide wheel 12 and/or to raise the circumference of the guide wheel 12 at least approximately into this plane 15A, 15B, 15B′.

The swivel devices 13, via which the support wheels 14 are arranged in a swivable way on the booms 2B, are also coupled to the coupling control device in such a way that each time a boom 2B is moved from the working position to the transport position, the swivel device 13 swivels the corresponding support wheel 14 into a lift-out position. The support wheels 14 are disposed at least partially in the plane 15B, 15B′ in the lift-out position, so that the soil-working device 1 has a further reduced transverse projection in the transport position, as shown in FIG. 4.

In this soil-working device 1, the coupling control device is configured as a hydraulic master circuit, so that whenever a boom 2B is moved from the working position to the transport position, the height-guiding devices 7d-7f on the tool carrier 6d-6f arranged on the base segment 2A can be controlled exclusively in the direction of the lowered position, the height-guiding devices 7a-7c, 7g-7i on tool carriers 6a-6c, 6g-6i arranged on the booms 2B can be controlled exclusively in the direction of the raised position and the swivel devices 13 can be controlled exclusively in the direction of the lift-out position. The hydraulic cylinders 3′ of the folding device 3, the actuators 11 of the height-guiding devices 7a-7i, which are configured as hydraulic cylinders, as well as the swivel devices 13, which also have a hydraulic actuator, are connected by means of the hydraulic master circuit in such a way that the movement of the soil-working device 1 follows a predetermined sequence of movements. The soil-working device 1 can thus be moved from the working position to the transport position in a particularly easy, safe and useful way, wherein operating errors or collisions are avoided. The following steps are carried out:
Folding of the boom 2B from the working position extending transversely to the direction of travel F, as shown in FIG. 1, into the transport position angled by at least approximately 90 degrees by means of the folding device 3,
Lowering of tool carriers 6d-6f arranged on the base segment 2A by means of the corresponding height-guiding devices 7d-7f,
Lifting of tool carriers 6a-6c, 6g-6i arranged on the booms 2B by means of the corresponding height-guiding devices 7a-7c, 7g-7i, and/or
Lifting of the support wheels 14 by means of the swivel devices 13.

REFERENCE SIGNS LIST
1 Soil-working device
2 Frame
2A Base segment
2B Boom
F Direction of travel
3 Folding device
3′ Hydraulic cylinder
4 Attachment device
5 (Horizontal) axis
6a — i Tool carrier
7a — i Height-guiding device
8 Plant rows
9a Soil-working tools
9b Weeder
10 Parallelogram-type suspension
11 Actuator
12 Guide wheel
13 Swivel device
14 Support wheel
15A, B, B′ Plane
A Distance

1. A soil-working device for row crops, comprising:
a frame which extends transversely with respect to the direction of travel in a working position and which has a base segment and at least one boom which is able to be folded with respect to the base segment;
a folding device for moving the at least one foldable boom between the working position and a transport position in which it is folded by at least approximately 90 degrees, and
a plurality of tool carriers which are arranged on the frame via in each case a remotely adjustable height-guiding device, wherein soil-working tools assigned to individual plant rows are arranged on the tool carriers, characterized in that the folding device and at least the height-guiding devices of tool carriers arranged on the base segment are coupled to one another by means of a, preferably hydraulic, coupling control device in such a way that, for each movement of a boom from the working position into the transport position, the height-guiding devices of tool carriers arranged on the base segment move the tool carriers into a position in which they are lowered relative to the frame.

2. The soil-working device of claim 1, wherein the height-guiding devices of tool carriers arranged on a boom are coupled to the coupling control device in such a way that each time a boom is moved from the working position to the transport position, the height-guiding devices of tool carriers arranged on a boom move the tool carriers into a raised position.

3. The soil-working device of claim 1, further comprising at least one support wheel, which is arranged on the frame, in particular a boom, via a remotely adjustable swivel device, preferably on the side facing away from the tool carriers.

4. The soil-working device of claim 3, wherein the at least one swivel device is coupled to the coupling control device in such a way that whenever a boom is moved from the working position to the transport position, the swivel device swivels the at least one support wheel into a lift-out position.

5. The soil-working device of claim 1, wherein the height-guiding devices are each configured to move the tool carrier into positions spaced at least 30 centimeters apart, preferably at least 40 centimeters apart.

6. The soil-working device of claim 1, wherein the height-guiding devices comprise a releasable fixing device, which is preferably configured as a clamping device, for arranging the tool carriers on the frame, so that the tool carriers can be arranged on the frame at adjustable distances transversely to the direction of travel.

7. The soil-working device of claim 2, wherein at least the height-guiding devices on a tool carrier arranged on a boom are lockable, preferably in the folded transport position of the soil-working device.

8. The soil-working device of claim 1, wherein the coupling control device is configured as a hydraulic master circuit, so that whenever a boom is moved from the working position to the transport position, the height-guiding devices on the tool carrier arranged on the base segment can be controlled exclusively in the direction of the lowered position, the height-guiding devices on tool carriers arranged on a boom can be controlled exclusively in the direction of the raised position and/or the swivel devices can be controlled exclusively in the direction of the lift-out position.

9. The soil-working device of claim 1, wherein the frame comprises the base segment and two booms, in that the booms are arranged so as to be foldable about a respective horizontal axis, in front of the base segment in the direction of travel.

10. The soil-working device of claim 9, wherein the base segment and the booms are superimposed adjacent to the horizontal axis, in particular transversely to the direction of travel.
